(19) United States
(12) Patent Application Publication
(10) Pub. No.: US 2013/0288835 A1
(43) Pub. Date: Oct. 31, 2013

(54) TRACTION DRIVE OF AN INTERNAL COMBUSTION ENGINE AND METHOD FOR OPERATING SAME

(71) Applicants: Christian Hauck, Altdorf (DE); Martin Rauch, Hirschaid (DE)

(72) Inventors: Christian Hauck, Altdorf (DE); Martin Rauch, Hirschaid (DE)

(73) Assignee: Schaeffler Technologies AG & Co KG, Herzogenaurach (DE)

(21) Appl. No.: 13/980,676

(22) PCT Filed: Oct. 26, 2011
(86) PCT No.: PCT/EP2011/068752

§ 371 Date: Jul. 19, 2013

(30) Foreign Application Priority Data
Jan. 27, 2011 (DE) 102011003227.4

(51) Int. Cl. F02B 67/06; F16H 7/02

(52) U.S. Cl. CPC F02B 67/06; F16H 7/02
USPC 474/87

(57) ABSTRACT

A traction drive of an internal combustion engine and a method for operating same. In two drive planes the traction drive includes an auxiliary drive (1) and a starter (7) and enables, in addition to a normal operating mode, the following operating modes: starting of the internal combustion engine, boosting of the internal combustion engine, auxiliary air conditioning and decoupling of the auxiliary drive (1).

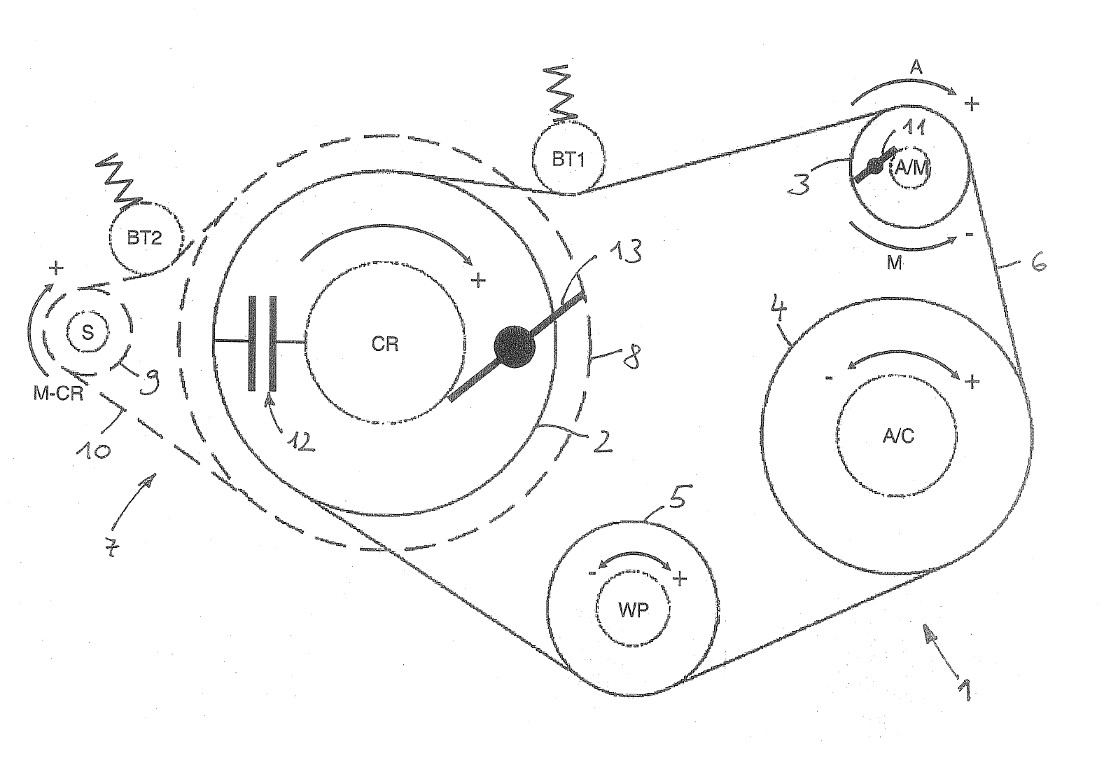

### BACKGROUND

The invention relates to a traction drive of an internal combustion engine and to a method for operating same. The traction drive comprises an auxiliary unit drive, which extends in a first drive plane, a starter drive, which extends in a second drive plane parallel to the first drive plane, and:
a first crankshaft wheel, which can be connected for rotation, by means of a controllable clutch, to a crankshaft of the internal combustion engine,
an electric machine, which can be operated either as a generator or, in the opposite direction of rotation, as a motor, and a machine wheel, which can be connected for rotation to the electric machine,
an air conditioning compressor, which is designed for a compression mode in both directions of rotation, and a compressor wheel, which can be connected for rotation to the air conditioning compressor,
a first traction means, which revolves in an endless manner in the first drive plane and is wrapped around the first crankshaft wheel, the machine wheel and the compressor wheel,
a second crankshaft wheel, which is arranged coaxially with the first crankshaft wheel and can be connected for rotation to the crankshaft,
an engine starter and a starter wheel, which can be connected for rotation to the engine starter,
and a second traction means, which revolves in an endless manner in the second drive plane and is wrapped around the second crankshaft wheel and the starter wheel.

A double belt drive of the type in question is disclosed by DE 10 2010 054 630 A1, which is not a prior publication. The electric machine proposed there is operated either as a driven generator or as a driving motor in the direction of rotation of the crankshaft. Here, the motor mode, in which the crankshaft is driven in the direction of rotation thereof, comprises a starting mode for starting the internal combustion engine and what is known as a “boost mode”, in which the crankshaft is driven not only by the internal combustion engine but also by the electric motor for the purpose of boosting the torque.

A further motor mode of the electric machine is used for what is known as “stationary air conditioning” for cooling the vehicle driven by the internal combustion engine. Here, the electric machine drives the air conditioning compressor, which is designed for a compression mode in both directions of rotation, in the opposite direction of rotation while the internal combustion engine is stationary.

### SUMMARY

It is the underlying object of the invention to simplify the design of a traction drive of the type stated at the outset and to indicate a method for operating a traction drive of this kind.

In terms of apparatus and method, the solution to this object is obtained from one or more features of the invention. Advantageous embodiments of the invention can be found below and in the claims.

Accordingly, the electric machine and the engine starter are separate electric units. In contrast to the situation in the cited prior art, therefore, there is no provision for an integrated unit in the form of a starter/generator machine which serves both as an electric machine that drives the crankshaft and a generator which is driven by the crankshaft. On the contrary, the invention provides two structurally separate individual machines which are designed in a technically specific and optimum manner for their respective purposes.

On the one hand, the electric engine starter can be either a high-grade machine with power electronics which also allows the abovementioned boost mode or, alternatively, a very low-cost machine without power electronics which is intended purely for starting the engine. The electric machine, which is separate therefrom, combines the functions of the generator, which supplies the vehicle electrical system with power, and of a motor, which does not drive the crankshaft but only the air conditioning compressor and, if required, further auxiliary units in “reverse” rotation. For this stationary air conditioning mode, it may be sufficient for the motor merely to be capable of being switched on and off, without complex control/regulation, in order to drive the air conditioning compressor at a constant speed of rotation, e.g. at 1500 rpm. Since the driving torque required for this purpose is significantly lower than that for starting or boosting the internal combustion engine, the motor can be of relatively simple dimensions, with corresponding cost advantages.

For operating the traction drive according to the invention, at least one of the following operating modes is provided:
a starting mode, in which the engine starter drives the crankshaft until the internal combustion engine starts,
a normal operating mode, in which the controllable clutch is closed and the electric machine, which is operated as a generator, is driven by the crankshaft of the running internal combustion engine,
a boost mode, in which the starter motor provides assistance in driving the crankshaft of the running internal combustion engine,
an OFF mode, in which the controllable clutch is open and the auxiliary unit drive is decoupled from the crankshaft of the running internal combustion engine,
a stationary air conditioning mode when the internal combustion engine is stationary, in which the controllable clutch is open and the electric machine, which is operated as a motor, drives the air conditioning compressor or a coolant pump, which is arranged in the auxiliary unit drive, in a direction of rotation opposite to that in the generator mode.

Control/regulation of the individual operating modes is accomplished with the aid of various state variables, particularly those of the internal combustion engine, of the vehicle interior temperature and the operating state of the controllable clutch.

A nonpositively acting poly-V belt is provided as a preferred traction means for the auxiliary unit drive, and a positively acting toothed belt is provided as a preferred traction means for the starter drive. However, a traction drive according to the invention can also be a chain/chain drive or a belt/chain drive.

It is likewise possible for further auxiliary units, possibly also in further drive planes, to be provided. In particular, this concerns the coolant pump arranged in the auxiliary unit drive for the purpose of cooling the internal combustion engine. Thus, the coolant pump, like the air conditioning compressor, can be driven “in reverse” by the electric machine when the internal combustion engine is stationary in order to supply the heating heat exchanger of the vehicle with warm cooling water (stationary heating). The radial pumps that are now customary supply a volume flow in the same direction, even when the direction of rotation of the drive is reversed, but this is only about 30% of the volume flow in the normal operating mode. However, this may be sufficient to maintain the internal temperature of the vehicle.

### BRIEF DESCRIPTION OF THE DRAWINGS

Further features of the invention will emerge from the following description and from the single FIGURE, in which a traction drive according to the invention for a motor vehicle internal combustion engine (not shown) is disclosed schematically.

The traction drive is embodied as a double belt drive in two mutually parallel drive planes. The auxiliary unit drive 1, which extends in the first drive plane and is illustrated with a solid line, comprises a first crankshaft wheel 2, which is arranged on the crankshaft CR of the internal combustion engine, an electric machine A/M, which can be operated either as a generator A or, in the opposite direction of rotation, as a motor M and has a machine wheel 3, an air conditioning compressor A/C having a compressor wheel 4, a coolant pump WP having a pump wheel 5, a first traction means 6 in the form of a poly-V belt which revolves in an endless manner and is wrapped around wheels 2 to 5, and a first tensioning device BT1 in the form of a known spring-loaded belt tensioner, which pretensions the first traction means 6 in the slack side thereof, between the first crankshaft wheel 2 and the machine wheel 3.

The reverse direction of rotation in the motor mode M to that in the generator mode A prevents drive-induced swapping of the tight side and the slack side in the auxiliary unit drive 1, and therefore the first tensioning device BT1 is arranged in the slack side and hence always in a functionally optimum manner, both when the internal combustion engine is running, i.e. when the crankshaft CR is driving, and when the internal combustion engine is stationary, i.e. when the crankshaft CR is being driven.

The starter drive 7, which extends in the second drive plane and is illustrated in dashed lines here, comprises a second crankshaft wheel 8, which is arranged on the crankshaft CR coaxially with the first crankshaft wheel 2, an electric engine starter S having a starter wheel 9, a second traction means 10 in the form of a toothed belt which revolves in an endless manner and is wrapped around wheels 8, 9, and a second tensioning device BT2, likewise in the form of a known belt tensioner, which pretensions the second traction means 10 in the slack side thereof, between the starter wheel 9 and the second crankshaft wheel 8. The power characteristic of the engine starter S, which can be operated purely in the positive direction of rotation M-CR and purely as a motor, is matched both to the torque requirement of the internal combustion engine to be started and—in combination with suitable power electronics—to the torque requirement of the running internal combustion engine in boost mode. The torque that can be transmitted to the crankshaft CR corresponds to the relatively large transmission ratio between the starter wheel 9 and the second crankshaft wheel 8.

The operational direction of rotation of the crankshaft CR corresponds to the direction of rotation indicated by a positive sign. The direction of rotation of the electric machine A/M is positive when the electric machine is in the generator mode A and is driven by the crankshaft CR. The direction of rotation of the electric machine A/M has a negative sign when the electric machine is in the motor mode M and, with the internal combustion engine stationary, drives the compressor wheel 4 and the pump wheel 5 in a correspondingly reversed direction of rotation for the purpose of cooling or heating the vehicle interior. The electric machine A/M has a significantly lower power consumption than known starter/generator machines and, in the motor mode M, is designed only to drive the air conditioning compressor A/C and the coolant pump WP at a constant speed of rotation of about 1500 rpm.

The air conditioning compressor A/C is a swashplate compressor, which is designed for a compression mode in both directions of rotation and is inserted into the refrigerant circuit of the vehicle air conditioning system with a corresponding freedom in terms of direction of rotation. The compressor wheel 4 can be connected for rotation to the air conditioning compressor A/C by means of a controllable magnetic clutch (not shown).

A reversal in the direction of rotation in accordance with the current operating mode is also provided in the case of the coolant pump WP, which is designed as a radial pump and, like the air conditioning compressor A/C, is designed for a pumping mode in both directions of rotation.

In the auxiliary unit drive 1, the machine wheel 3 is connected to the electric machine A/M for rotation by means of a one-way clutch 11 in the form of a one-way roller clutch, which allows overrunning of the electric machine A/M relative to the machine wheel 3 in the positive direction of rotation and hence relative to the crankshaft CR and locks up in the opposite, negative direction of rotation. The one-way roller clutch 11 is embodied as a one-way generator clutch known per se for the purpose of decoupling the generator A, wherein the inner ring thereof, which is provided with wedging ramps for the wedging rollers, rotates with the electric machine A/M and wherein the cylindrical outer ring thereof rotates with the machine wheel 3 (one-way clutch with profiled internal race).

As an alternative to a one-way clutch of this kind, spring decoupling with stops on both sides or, in principle, also a rigid connection between the machine wheel 3 and the electric machine A/M can be provided for the electric machine A/M.

The rotary connection between the first crankshaft wheel 2 and the crankshaft CR is accomplished by means of an electrically controllable magnetic clutch 12. This can be either open when deenergized or closed when deenergized. In the open state of the magnetic clutch 12, the auxiliary unit drive 1 is operationally decoupled from the crankshaft CR. Decoupling is required in order to be able to drive the air conditioning compressor A/C and the coolant pump WP in isolation when the internal combustion engine is stationary and, consequently, the crankshaft CR is stationary, and hence to be able to perform stationary air conditioning or stationary heating of the vehicle. Decoupling furthermore enables the auxiliary unit drive 1 to be stopped when the internal combustion engine is running, in order to minimize operational frictional losses.

In the starter mode 7, the rotary connection between the second crankshaft wheel 8 and the crankshaft CR is accomplished by means of a further one-way clutch 13 in the form of a one-way roller clutch, which allows overrunning of the crankshaft CR relative to the second crankshaft wheel 8 in the positive direction of rotation and locks up in the opposite direction of rotation. In terms of design, the one-way roller clutch 13 is arranged in such a way that the cylindrical inner ring thereof rotates with the second crankshaft wheel 8 and that the outer ring thereof, which is provided with wedging ramps for the wedging elements, rotates with the crankshaft CR (one-way clutch with profiled external race). As compared with pinion starters which mesh abruptly, this design embodiment allows start/stop operation of the internal combustion engine with “change-of-mind starting”, in which case the still-rotating crankshaft CR of the internal combustion engine, which has already been switched off, is driven until restarting.

The traction drive allows the following operating modes:

a) a starting mode, in which the engine starter S drives the crankshaft CR from the stationary condition until the internal combustion engine starts:
the engine starter S is in the motor mode M-CR with a positive direction of rotation,
the magnetic clutch 12 is closed (but can also be open),
the crankshaft CR is driven by means of the starter drive 7 and the locked further one-way clutch 13 and drives the auxiliary unit drive 1 by means of the closed magnetic clutch 12 and the first crankshaft wheel 2,
the internal combustion engine starts and, with the internal combustion engine running, the further one-way clutch 13 allows overrunning of the crankshaft CR relative to the second crankshaft wheel 8,
the engine starter S can be switched off, and therefore the starter drive 7 stops.
   b) a normal operating mode, in which the electric machine A/M is driven by the crankshaft CR of the running internal combustion engine:
the starter drive 7 is stationary,
the magnetic clutch 12 is closed, and the crankshaft CR drives the auxiliary unit drive 1 by means of the first crankshaft wheel 2, and
the electric machine A/M is in the generator mode A with a positive direction of rotation, wherein the one-way clutch 11 acts as a one-way generator clutch which decouples the electric machine A/M from the crankshaft CR,
the compressor wheel 4 and the pump wheel 5 are driven in a positive direction of rotation,
the first belt tensioner BT1 is in the slack side of the auxiliary unit drive 1.
   c) a boost mode, in which the starter motor S provides assistance in driving the crankshaft CR with the internal combustion engine running:
the starter motor S is in the motor mode M-CR with a positive direction of rotation,
the magnetic clutch 12 is closed (but can also be open),
the rotating crankshaft CR is additionally driven by means of the starter drive 7 with the further one-way clutch 13 locked.
   d) an OFF mode, in which the auxiliary unit drive 1 is decoupled from the crankshaft CR of the running internal combustion engine:
the magnetic clutch 12 is open,
the auxiliary unit drive 1 is stationary,
the starter drive 7 is stationary or in the boost mode,
the auxiliary unit drive 1 is decoupled by closing the magnetic clutch 12. To reduce transient load peaks during the rotational synchronization of the crankshaft CR and the auxiliary unit drive 1, it may be expedient to close the magnetic clutch 12 intermittently within the synchronization phase and in a controlled manner in such a way that the driving torque that can be transmitted by the magnetic clutch 12 is always less than a limiting torque, the exceeding of which would lead to slip of the poly-V belt 6 to an unwanted degree.
   e) a stationary air conditioning mode/stationary heating mode, in which the electric machine A/M drives the air conditioning compressor A/C and/or the coolant pump WP when the internal combustion engine is stationary:
the magnetic clutch 12 is open and the auxiliary unit drive 1 is decoupled from the crankshaft CR,
the electric machine A/M is in the motor mode M with a reverse direction of rotation relative to that in generator mode A,
the one-way clutch 11 is in the wedged position, and the compressor wheel 4, the pump wheel 5 and the first crankshaft wheel 2 are driven in the negative direction of rotation,
the first belt tensioner BT1 is in the slack side of the auxiliary unit drive 1.

### LIST OF REFERENCE SIGNS

1 auxiliary unit drive
2 first crankshaft wheel
3 machine wheel
4 compressor wheel
5 pump wheel
6 first traction means, poly-V belt
7 starter drive
8 second crankshaft wheel
9 starter wheel
10 second traction means, toothed belt
11 one-way clutch, one-way roller clutch
12 magnetic clutch
13 further one-way clutch, one-way roller clutch
CR crankshaft
S engine starter
M-CR motor mode of the starter motor
A/M electric machine
A/C air conditioning compressor
A generator mode
M motor mode of the electric machine
WP coolant pump
BT1 first tensioning device
BT2 second tensioning device

1. A traction drive of an internal combustion engine, comprising an auxiliary unit drive, which extends in a first drive plane, a starter drive, which extends in a second drive plane parallel to the first drive plane, and:
a first crankshaft wheel, which is connectable for rotation, by a controllable clutch, to a crankshaft of the internal combustion engine,
an electric machine, which is operable either as a generator or, in an opposite direction of rotation, as a motor, and a machine wheel, which is connected for rotation to the electric machine,
an air conditioning compressor, which is designed for a compression mode in both directions of rotation, and a compressor wheel, which is connected for rotation to the air conditioning compressor,
a first traction element, which revolves in an endless manner in the first drive plane and is wrapped around the first crankshaft wheel, the machine wheel and the compressor wheel,
a second crankshaft wheel, which is arranged coaxially with the first crankshaft wheel and is connected for rotation to the crankshaft,
an engine starter and a starter wheel, which is connected for rotation to the engine starter,
and a second traction element, which revolves in an endless manner in the second drive plane and is wrapped around the second crankshaft wheel and the starter wheel, and
the electric machine and the engine starter are separate electric units.

2. The traction drive as claimed in claim 1, wherein the traction drive furthermore comprises:
a coolant pump, which is designed for a pumping mode in both directions of rotation, and a pump wheel, which is connected for rotation to the cooling pump and around which the first traction element is wrapped.

3. The traction drive as claimed in claim 1, wherein a first tensioning device for pretensioning the first traction element is arranged in a region of a slack side of the first traction element, said slack side extending between the first crankshaft wheel and the machine wheel.

4. The traction drive as claimed in claim 1, wherein a second tensioning device for pretensioning the second traction element is arranged in a region of a slack side of the second traction element, said slack side extending between the second crankshaft wheel and the starter wheel.

5. The traction drive as claimed in claim 1, wherein a one-way clutch, which allows overrunning of the electric machine relative to the machine wheel in a direction of rotation of a generator mode, is arranged between the machine wheel and the electric machine.

6. The traction drive as claimed in claim 5, wherein a further one-way clutch, which allows overrunning of the crankshaft relative to the second crankshaft wheel in the direction of rotation of the crankshaft, is arranged between the second crankshaft wheel and the crankshaft.

7. A method for operating a traction drive of an internal combustion engine, comprising an auxiliary unit drive, which extends in a first drive plane, a starter drive, which extends in a second drive plane parallel to the first drive plane, and:
a first crankshaft wheel, which is connected for rotation, by a controllable clutch, to a crankshaft of the internal combustion engine,
an electric machine, which is operable either as a generator or, in an opposite direction of rotation, as a motor, and a machine wheel, which is connected for rotation to the electric machine,
an air conditioning compressor, which is designed for a compression mode in both directions of rotation, and a compressor wheel, which is connected for rotation to the air conditioning compressor,
a first traction element, which revolves in an endless manner in the first drive plane and is wrapped around the first crankshaft wheel, the machine wheel and the compressor wheel,
a second crankshaft wheel, which is arranged coaxially with the first crankshaft wheel and is connected for rotation to the crankshaft,
an engine starter and a starter wheel, which is connected for rotation to the engine starter,
and a second traction element, which revolves in an endless manner in the second drive plane and is wrapped around the second crankshaft wheel and the starter wheel,
wherein the electric machine and the engine starter are separate electric units, and the method includes operating in at least one of the following operating modes:
a starting mode, in which the engine starter drives the crankshaft until the internal combustion engine starts,
a normal operating mode, in which the controllable clutch is closed and the electric machine, which is operated as a generator, is driven by the crankshaft of the running internal combustion engine,
a boost mode, in which the starter motor provides assistance in driving the crankshaft of the running internal combustion engine,
an OFF mode, in which the controllable clutch is open and the auxiliary unit drive is decoupled from the crankshaft of the running internal combustion engine,
and a stationary air conditioning mode when the internal combustion engine is stationary, in which the controllable clutch is open and the electric machine, which is operated as a motor, drives the air conditioning compressor or a coolant pump, which is arranged in the auxiliary unit drive, in a direction of rotation opposite to that in the generator mode.
